(19) United States
(12) Patent Application Publication
(10) Pub. No.: US 2011/0236722 A1
(43) Pub. Date: Sep. 29, 2011

(54) COATING METHOD AND APPARATUS, METHOD OF MAKING SUBSTRATE ROLL, AND MAGNETIC TAPE

(75) Inventors: Toshihiro MANDAI, Kanagawa (JP); Tomohiro SATOU, Kanagawa (JP); Satoshi NAGANO, Kanagawa (JP)

(73) Assignee: FUJIFILM CORPORATION, Tokyo (JP)

(21) Appl. No.: 13/074,443

(22) Filed: Mar. 29, 2011

(30) Foreign Application Priority Data
Mar. 29, 2010 (JP) 2010-076464

(51) Int. Cl. B05D 5/00; B05C 5/02; B05D 1/26; B05D 3/12; G11B 5/62

(52) U.S. Cl. 428/800; 427/256; 118/407; 427/177

(57) ABSTRACT

A method of coating a moving web of a substrate with a coating, includes applying the coating to the substrate to provide a coating thickness distribution curve along a width direction of the substrate such that: the coating thickness decreases from a position where the thickness is the maximum to the opposite ends of the curve and that the distribution curve has the least curvature at the position with the maximum thickness and contains an end portion having a larger curvature than that of the position with the maximum thickness on both sides of the position with the maximum thickness.

### CROSS-REFERENCE TO RELATED APPLICATIONS

This application claims the benefit of Japanese Patent Application JP 2010-076464, filed Mar. 29, 2010, the entire content of which is hereby incorporated by reference, the same as if set forth at length.

### FIELD OF THE INVENTION

This invention relates to a coating method, a coating apparatus, a method of making a substrate roll, and magnetic tape.

### BACKGROUND OF THE INVENTION

Magnetic recording media such as magnetic tape are obtained by coating a substrate with a coating having a composition according to the intended use.

Production of a magnetic recording medium such as magnetic tape includes the steps of feeding a web of a substrate wider than the tape width, applying a coating containing a magnetic material to the moving web using a coating apparatus to form a magnetic layer, and slitting the coated web to widths.

Methods for applying a coating to a substrate include roller coating, gravure coating, roller plus doctor coating, extrusion coating, and slide coating. Various coating apparatus appropriate to the coating methods have been used.

Recently, extrusion coating is used frequently. Extrusion coating is performed using a coating apparatus equipped with a coating head having a slot facing a moving substrate through which a coating is extruded and applied to the substrate. Extrusion coating is advantageous in that a thin coating layer is formed at a high speed and is especially suited to the manufacture of magnetic tape having a high recording density magnetic layer. Among known techniques of extrusion coating is the methods disclosed in JP 2005-125218A and JP 61-293577A.

### SUMMARY OF THE INVENTION

When a substrate moving at a high speed is coated as in the case of extrusion coating, air can be entrained between adjacent layers of the coated substrate while being wound up into roll form. The entrained air reduces the friction force between the adjacent layers of the substrate. As a result, the substrate being wound can be laterally displaced by slight disturbance, resulting in what we call scatterwinding (winding deficiency).

In the manufacture of magnetic tape, winding a coated substrate into roll form is sometimes followed by a thermal treatment for thermally hardening the coating layer. In this case, the part of the substrate of roll form where air is entrained can undergo deformation by heat, resulting in deteriorated linearity of the finally obtained magnetic tape.

JP 2005-125218A and JP 61-293577A propose applying a coating in the laterally central portion of a substrate web thicker than in the edge portions so as to secure good winding quality of the resulting roll of the substrate. To meet the demand for further improved tape quality, it has still been sought to achieve stable winding with high precision while allowing air to bleed from between adjacent layers more efficiently. The coating techniques of JP 2005-125218A and JP 61-293577A are not necessarily sufficient for air bleeding, still leaving a room for improvement.

An object of the invention is to provide a coating method and apparatus and a method of making a roll of a coated substrate that permit a coated substrate to be wound into roll form while efficiently preventing air entrainment to provide a roll having a stable shape at high precision.

The invention provides in its first aspect a method of coating a moving web of a substrate with a coating. The method includes applying the coating to the substrate to form a coating thickness distribution curve across the substrate such that the coating thickness decreases from a position with the maximum thickness to the opposite ends of the curve and that the distribution curve has the least curvature at the position with the maximum thickness and contains an end portion having a larger curvature than that of the position with the maximum thickness on both sides of the position with the maximum thickness.

The invention also provides in its second aspect an apparatus for coating a moving web of a substrate with a coating. The apparatus includes a cavity for containing a coating, a slot connecting to the cavity and having an opening through which the coating is applied to the substrate, and a configuration for adjusting the weight of the coating to be applied to the substrate so as to depict a coating weight distribution curve across the substrate such that the coating weight decreases from a position where it reaches the maximum to the opposite directions along the width direction of the substrate and that the distribution curve has a portion including the position with the maximum coating weight and having the least curvature and a portion which is located on each side of the first described portion and has a larger curvature than the position with the maximum coating weight.

The invention also provides in its third aspect a method of making a wound roll of a web of a substrate coated with a coating layer. The method includes the step of applying a coating to the substrate to form a coating thickness distribution curve across the substrate such that the thickness of the coating layer decreases from a position where the thickness is the maximum to the opposite edges of the substrate along the width direction of the substrate and that the distribution curve has a portion including the position with the maximum thickness and having the least curvature and a portion which is located on each side of the first described portion and has a larger curvature than the position with the maximum coating thickness and the step of winding the web of the substrate coated with the coating into roll form.

The invention also provides in its fourth aspect a magnetic tape obtained by using the method for making a wound roll of a substrate. The magnetic tape is obtained by applying a coating containing magnetic particles to a moving web of a substrate, drying and solidifying the applied coating, and slitting the coated substrate to width.

According to the invention, there are provided a coating method, a coating apparatus, and a method of making a roll of a coated substrate that permit a coated substrate to be wound into roll form while efficiently preventing air entrainment to provide a roll having a stable shape with high precision.

### BRIEF DESCRIPTION OF THE DRAWINGS

FIG. 1 is a schematic cross-section of a magnetic tape produced by the invention.

FIG. 2 is an illustration of an apparatus for producing a magnetic tape.

FIG. 3 is an illustration of a coating head of a coating apparatus.

FIG. 4 is a cross-section of the coating head.

FIG. 5 is a schematic view of the cavity of the coating head.

FIG. 6 is a graph showing the depth of the slot varying with the position in the width direction of the substrate to be coated.

FIG. 7 is a graph showing the thickness of a coating layer varying with the position in the width direction of the substrate.

FIG. 8 is a schematic cross-section of a substrate roll.

FIG. 9 shows another structure of a coating apparatus.

FIG. 10 is a graph showing the curvature radius of the cavity of the coating apparatus used in Example 1, the curvature radius varying with position in the width direction of the substrate.

FIG. 11 is a graph showing the thickness distribution of the coating layer formed on a substrate using the coating apparatus of Example 1.

FIG. 12 is a schematic view a cavity of the coating apparatus used in Example 2.

FIG. 13 is a graph showing the thickness distribution of the coating layer formed on a substrate using the coating apparatus of Comparative Example 1.

### DETAILED DESCRIPTION OF THE INVENTION

The following is the description of the procedures for producing a magnetic tape as a magnetic recording medium and the schematic illustration of an apparatus used therefor.

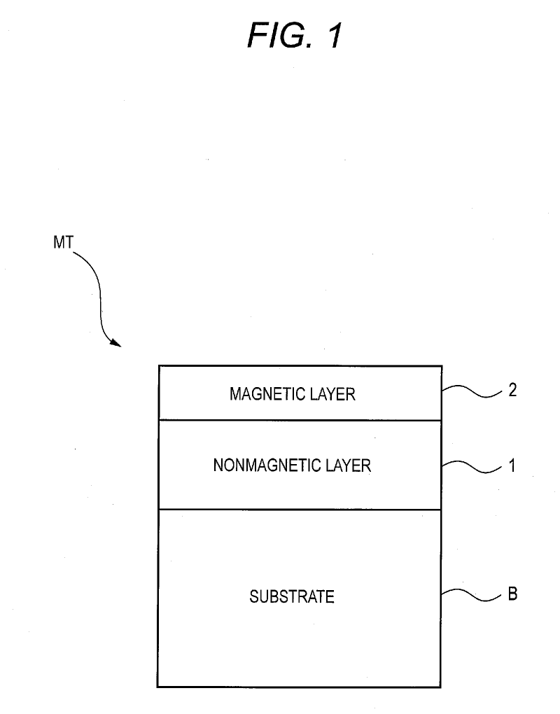

FIG. 1 schematically illustrates a cross-section of magnetic tape produced. Magnetic tape MT has a substrate B, a nonmagnetic layer 1 on the substrate B, and a magnetic layer 2 on the nonmagnetic layer 1.

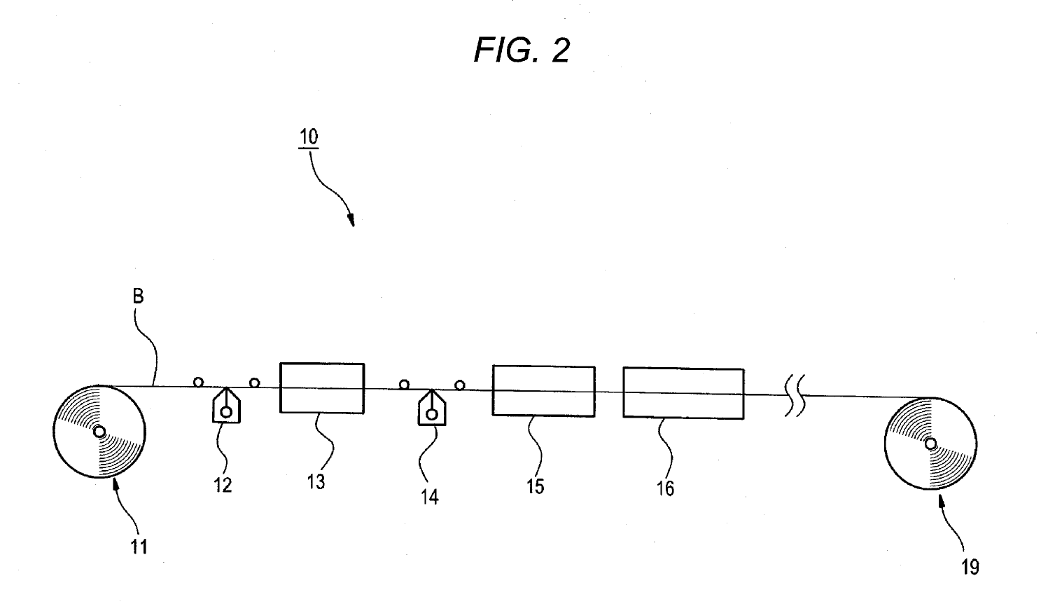

FIG. 2 illustrates the apparatus used to produce the magnetic tape. The apparatus 10 includes a feed roll 11 of a continuous web of a substrate B and a take-up roll 19 of the substrate B coated with a nonmagnetic layer and a magnetic layer. The apparatus 10 is to produce magnetic tape while moving the substrate B unrolled from the feed roll 11 along a transport path.

The apparatus 10 has, in downstream order, a coating station 12 for applying a nonmagnetic coating, a drying station 13 for drying a nonmagnetic coating, a coating station 14 for applying a magnetic coating, a drying station 15 for drying a magnetic coating, and a magnetic alignment station 16. Guide rollers are provided at appropriate locations along the transport path to support the back side of the moving substrate B opposite to the recording side (the side coated with the magnetic layer and the nonmagnetic layer).

The coating station 12 is to apply a nonmagnetic coating composition containing nonmagnetic particles to the lower side of the substrate B to form a nonmagnetic coating layer. Application of the nonmagnetic coating composition is preferably achieved by extrusion coating. Other coating techniques, such as gravure coating, roller coating, dip coating, slide coating, bar coating, and curtain coating, may be employed.

The drying station 13 is to dry the nonmagnetic coating layer formed in the coating station 12 to form a nonmagnetic layer. The substrate B having the thus formed nonmagnetic layer is transported to the downstream coating station 14.

The coating station 14 is to apply a magnetic coating composition containing magnetic particles to the nonmagnetic layer to form a magnetic coating layer. The thus formed magnetic coating layer moves downstream while wet. Application of the magnetic coating composition is carried out using the above described coating techniques.

The drying station 15 is to dry the magnetic coating layer not completely but to such a degree that allows alignment of the magnetic particles in the subsequent alignment station 16.

The alignment station 16 is to apply a magnetic field formed by magnets, such as permanent magnets, to the magnetic coating layer to align the magnetic particles. The alignment station 16 may be configured to blow drying air to accelerate drying the magnetic coating layer simultaneously with the alignment. Thus, the magnetic coating layer dries and solidifies to form a magnetic layer.

The substrate B with the magnetic layer and the nonmagnetic layer is rolled into a take-up roll 19.

While not shown in the drawing, the coated substrate B once rolled into the take-up roll 19 is unrolled and delivered to the step of calendering for surface smoothing with calender rollers, the step of thermal treatment for thermally curing the nonmagnetic layer and the magnetic layer, and the step of slitting in which the coated web is slit to width to complete magnetic tapes. A backcoat layer may be provided on the opposite side of the substrate B to the recording side.

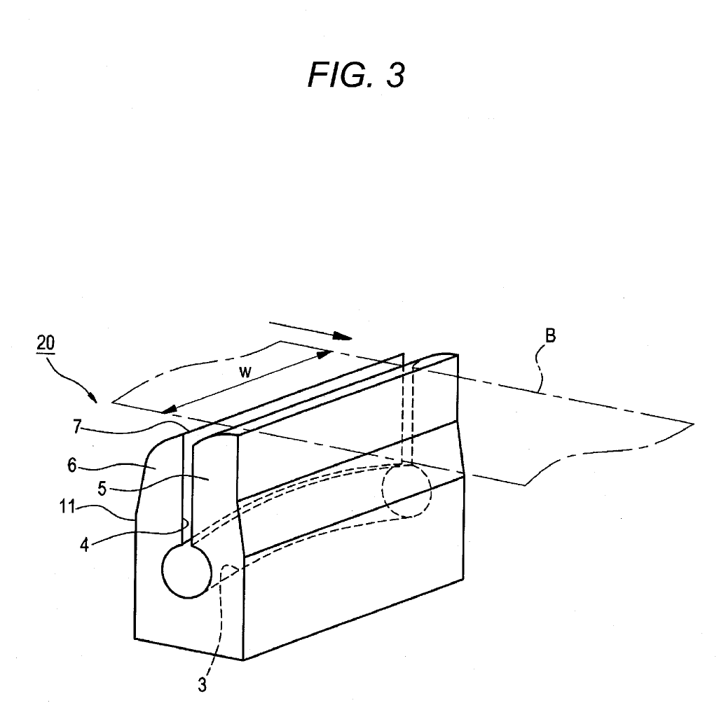

FIG. 3 is an illustration of a coating apparatus 20. The coating apparatus 20 of FIG. 3 is used to apply a nonmagnetic coating composition or a magnetic coating composition in the coating station 12 or 14, respectively. The nonmagnetic coating composition and the magnetic coating composition will hereinafter be referred to inclusively as a coating composition or simply a coating, and the coating method and apparatus of the invention will be described with reference to a simplified embodiment in which a coating composition is applied to a substrate.

As illustrated in FIG. 3, the coating apparatus 20 has a coating head 11, through which a coating composition is applied to a moving continuous web of a substrate B.

The coating head 11 has a upstream lip called a front edge portion 6, a downstream lip called a doctor edge portion 5, and a cavity 3 containing a coating. Between the front edge portion 6 and the doctor edge portion 5 is defined a slot 4 that connects to the cavity 3 at one end thereof. The slot 4 has an opening (or a mouth) 7 at the other end thereof, through which the coating composition is extruded.

The cavity 3 extends along the width direction W of the substrate B and has a nearly circular cross-section that is substantially the same over its whole length. The cross-section of the cavity 3 preferably has a radius of 4 to 18 mm.

The slot 4 pierces the coating head 11 from the cavity to the opening 7 with a predetermined lip clearance. The slot 4 provides a narrower channel than the cavity 3 extending in the width direction W of the substrate B. The (lip) clearance of the slot 4 is the width of the opening formed between the doctor edge portion 5 and the front edge portion 6. The clearance of the slot 4 is preferably 0.05 to 1.0 mm.

The material of the coating head 11 is preferably, but not limited to, a metal material. A hard material, such as stainless steel, is more preferred from the viewpoint of improved working accuracy. The coating head 11 may have an ultra hard material attached to the tip thereof or may be made of ceramics.

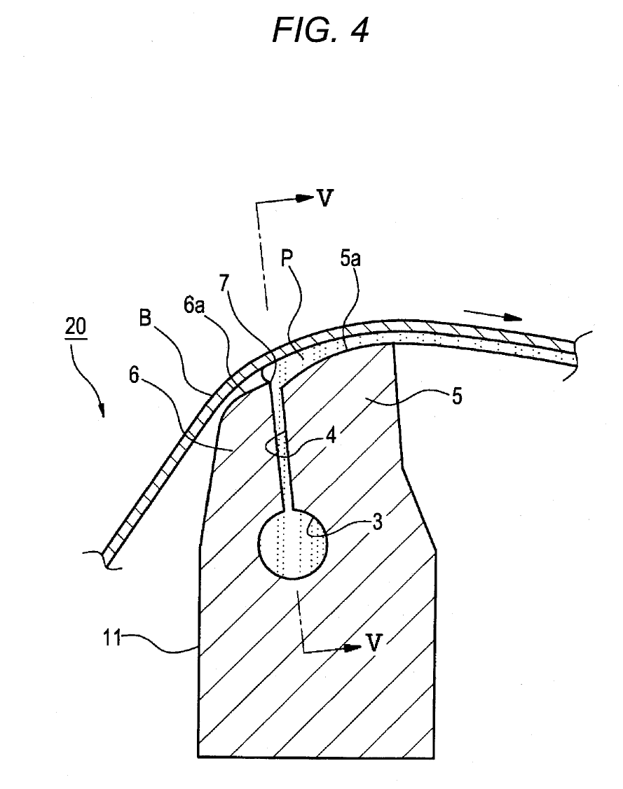

FIG. 4 is a cross-section of the coating head through which a coating P is being applied to a substrate B. The coating P in the cavity 3 is extruded from the opening 7 of the slot 4 and applied to the surface to be coated of the moving substrate B that faces the coating apparatus 20. That surface is the lower side of the substrate B in FIG. 4.

As illustrated in FIG. 4, the coating head has, in a downstream order, an upstream lip surface 6a at the tip of the front edge portion 6 and a downstream lip surface 5a at the tip of the doctor edge portion 5. The upstream lip surface 6a and the downstream lip surface 5a each have an arc-shaped cross-section with a respectively designed curvature. There is a level difference between the downstream end of the upstream lip surface 6a and the upstream end of the downstream lip surface 5a so that the coating P may be applied to the substrate B to a prescribed thickness.

The coating apparatus 20 is configured to give a coating weight distribution curve across the substrate B such that the coating weight decreases from a position where it reaches the maximum to the opposite directions along the substrate width direction and that the distribution curve contains a portion including the position with the maximum coating weight and having the least curvature and a portion which is located on each side of the first described portion in the substrate width direction and has a larger curvature than the position with the maximum coating weight. An embodiment of controlling the coating weight so as to provide the above mentioned coating weight distribution will be described below.

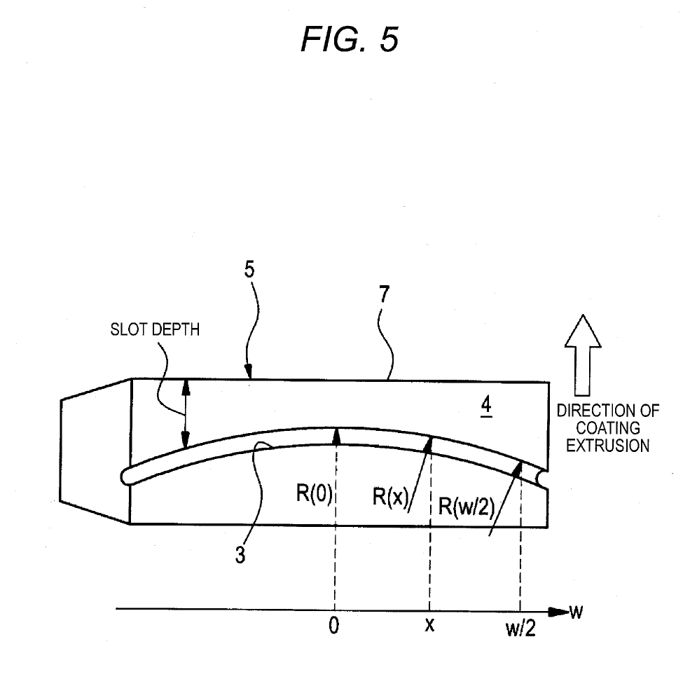

FIG. 5 schematically illustrates the shape of the cavity 3 formed in the doctor edge portion 5 of the coating head 11. FIG. 5 is a cross-section of the coating head 11 shown in FIG. 4, taken along line V-V and seen from the side of the front edge portion 6. In FIG. 5, the upper and the lower edges of the cavity 3 form equally shaped arcs with a curvature of radius (hereinafter curvature R) varying along the substrate width direction W. A position in the cavity 3 in the direction W is indicated with the letter x. The cavity 3 has a curvature R(0) at the center in the direction W, a curvature R(x) at a position x, which is x distant away from the center, in the direction W, and a curvature R(w/2) at one end thereof in the direction W. The cavity 3 is axisymmetric about the center in the direction W.

The curvatures R(0), R(x), and R(w/2) of the cavity 3 are related such that the central curvature R(0) is the least and the curvature increases toward both ends along the direction W to reach the largest, namely, R(0)<R(x)<R(w/2). To put it another way, the cavity 3 is formed along a single curve and has a curvature increasing from the position with the least curvature toward both ends thereof.

When the cavity 3 is configured as illustrated in FIG. 5, the depth of the slot 4, i.e., the distance from the cavity 3 to the opening 7 of the slot 4, varies with the position in the direction W. In the present embodiment, the slot depth is the smallest at the center and increases to the opposite directions along the direction W.

The cavity 3 can be formed in at least one of the front edge portion 6 and the doctor edge portion 5 by, for example, numerical control machining.

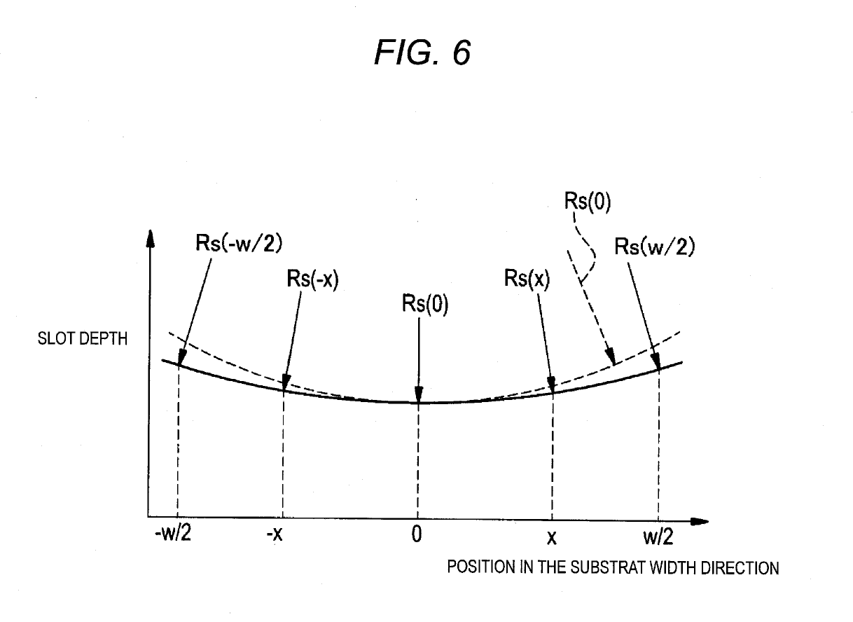

FIG. 6 is a graph showing the depth of the slot in the coating head varying with the position in the substrate width direction W. The solid curve represents the rate of change in slot depth, and the dotted curve is a comparative curve drawn from the center of the solid curve to opposite directions at a constant curvature Rs that is equal to the curvature at the center of the solid curve in the direction W.

The slot depth is the smallest at the center and the largest at the ends in the direction W. The curve representing the rate of change of slot depth has a curvature Rs(0) at the center, a curvature Rs(x) at a position x distant from the center, and a curvature Rs(w/2) at both ends in the direction W. The curvature Rs(0) is the least, and the curvature Rs increases toward the opposite ends in the direction W until it reaches the largest value Rs(w/2) at both ends. That is, the rate of change in slot depth decreases from the center to the opposite ends of the opening of the slot 4 in the substrate width direction W.

The coating weight of the coating extruded from a position in the opening where the slot depth is smaller is larger than that extruded from a position where the slot depth is larger. The coating weight of the coating extruded from a position in the opening where the slot depth is larger is smaller than that extruded from a position where the slot depth is smaller. Since the slot depth at the center of the opening is larger than that at both ends of the opening in the direction W, the coating weight at the center is larger than that at both ends of the slot opening. Since the slot depth increases from the center to both ends of the slot opening in the direction W, the coating weight decreases from the center toward both ends of the opening.

The thickness of the coating layer applied on the substrate using the coating head of the present embodiment will then be described.

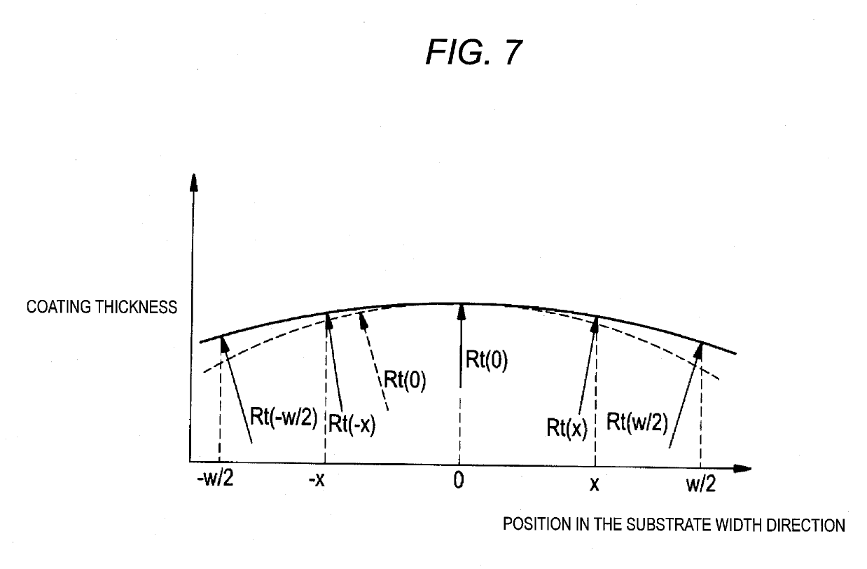

FIG. 7 is a coating thickness distribution curve showing the thickness of a coating layer varying with the position in the width direction of the substrate. The abscissa represents a position in the substrate width direction, and the ordinate represents the thickness of a coating layer. The coating thickness distribution curve as referred to here is a fitted curve based on the plots of the thickness data measured in the substrate width direction. A fitted curve is calculated by, for example, least square fit to the coating weight distribution data.

As shown in FIG. 7, the lateral center of the substrate is designated 0, and the position at the lateral edge of the coating layer is designated w/2. The coating layer thickness is largest at the lateral center and decreases toward both edges, depicting a distribution curve. The thickness distribution curve has a curvature Rt(0) at the center, a curvature Rt(x) at a position x distant from the center, and a curvature Rt(w/2) at one end in the substrate width direction W. The curvature Rt(0) is the least. The curvature Rt(x) increases from the center toward both edges of the substrate until it reaches the largest value Rt(w/2). That is, the coating is applied to form such a coating layer that has a thickness distribution in the substrate width direction such that (1) the thickness decreases from a position with the maximum thickness to the opposite directions along the substrate width direction and that (2) the thickness distribution curve contains a portion including the position with the maximum thickness (the lateral center 0 in FIG. 7) and having the least curvature and a portion which is located on each side of the first described portion in the substrate width direction and has a larger curvature than the position with the maximum thickness. In the embodiment shown in FIG. 7, the coating layer has a thickness distribution curve having the curvature gradually increasing from the lateral center to both ends thereof. The change in curvature may be either stepwise or continuous. When the curvature changes stepwise, the change points may obviously appear on the distribution curve or may be smoothed out to be made unapparent. When the curvature changes stepwise, the change may be such that the curvature at least a position x between, for example, w/6 and w/4 (i.e., between ½ and ⅔ of the distance from the edge of the coating layer to the lateral center) is larger than that at the center 0.

When a substrate coated with a coating layer with the thickness distribution of FIG. 7 by the use of the aforementioned coating apparatus is wound into a roll, the following action and effect are produced.

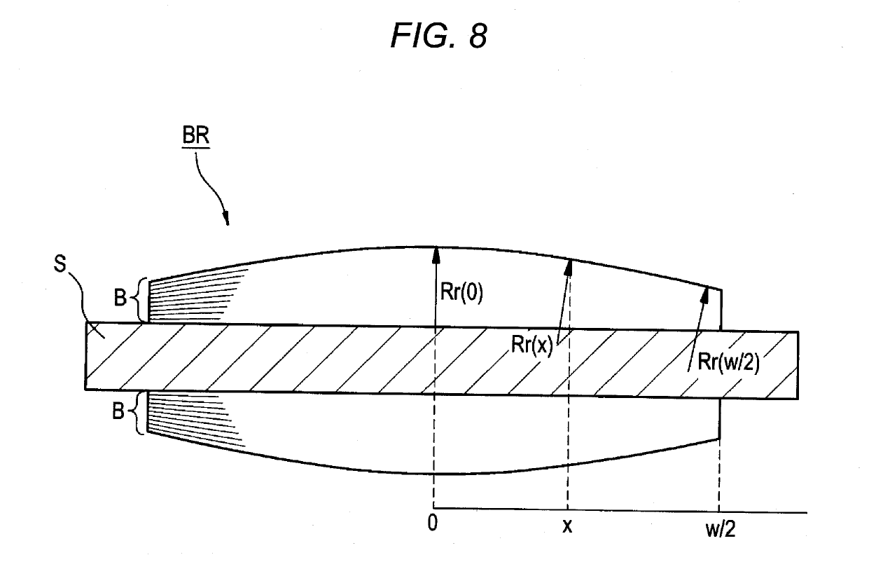

FIG. 8 is a schematic cross-section of a substrate roll BR. The substrate roll BR is a substrate B rolled up around a cylindrical core S. In FIG. 8, the position across the width of the substrate roll BR is indicated by the letter x. The position at the center in the substrate width direction is x=0, and the position at the edge of the substrate is x=w/2.

In a cross-sectional view of the substrate roll BR with a prescribed number of windings, attention is focused on the curve representing the surface of the outermost winding of the substrate B. Taking the curvature of the curve at a position x in the substrate width direction as Rr(x), the curvature Rr(0) at the center in the substrate width direction is the least, and the curvature Rr(x) increases from the lateral center toward the opposite ends of the curve to reach the maximum Rr(w/2) at the ends.

In winding the substrate B onto the substrate roll BR, air accompanying the substrate B is entrained between the adjacent, wound layers of the substrate B. The air being entrained is subjected to the pressure from the substrate B being successively wound up and flows across the width of the substrate B to the places subject to smaller pressure.

The pressure P imposed on the entrained air is a combination of a pressure p1 generated according to the number of windings (i.e., the winding length) and a pressure p2 generated according to the shape of the substrate B in the width direction.

The pressure p1 is exerted in the radial direction of the substrate roll BR and reduces generally inversely with the number of windings (i.e., the length of the wound substrate).

The pressure p2 is exerted in the width direction of the substrate roll BR and influenced by the shape of the substrate roll BR. The pressure p2 reduces generally inversely with the curvature radius Rr(x) of the substrate surface.

The pressure p1 is ignorable since it becomes smaller with the length of the wound substrate. On the other hand, since the pressure p2 depends on the shape of the substrate roll, it has a dominant influence on the entrained air. In other words, it is possible to control the pressure p2 by optimizing the shape of the substrate roll so as to help the entrained air to escape or bleed out smoothly from between adjacent layers being wound.

The shape of the substrate roll BR is controllable by the thickness distribution of the coating layer as described supra. This can be done by applying the coating to a substrate B to give a coating thickness distribution curve in the substrate width direction such that the thickness decreases from the position with the maximum thickness to both edges of the substrate B and that the curvature at both ends of the curve is larger than that at the position with the maximum thickness.

The cross-sectional shape of the substrate roll BR has the least curvature Rr(0) at the lateral center of the substrate B and has a curvature Rr(x) increasing from the center toward the edges. As a result, entrained air flows from the lateral center toward the edges of the substrate B. Since the curvature at the edges Rr(w/2) is the largest (larger than the curvature Rr(0)) in the curve, entrained air is allowed to escape through the edges easily, being prevented from staying in the edge portions of the substrate B. The coated substrate can thus be wound into a roll while eliminating accompanying air efficiently to provide a substrate roll having a stable shape at high precision. Additionally, thermal deformation of the substrate in roll form due to remaining air is prevented.

The above described coating method and apparatus are particularly effective in the step of preparing a substrate or making a roll of a substrate in the manufacture of magnetic tape. The coating method and apparatus are also effective in coating a 500 mm wide or wider web of a substrate moving at a high speed of 100 m/min or more.

A modification of the above described embodiment of the coating method and apparatus will then be illustrated. In the modification, the clearance of the opening of the slot varies in the substrate width direction at a prescribed rate of change.

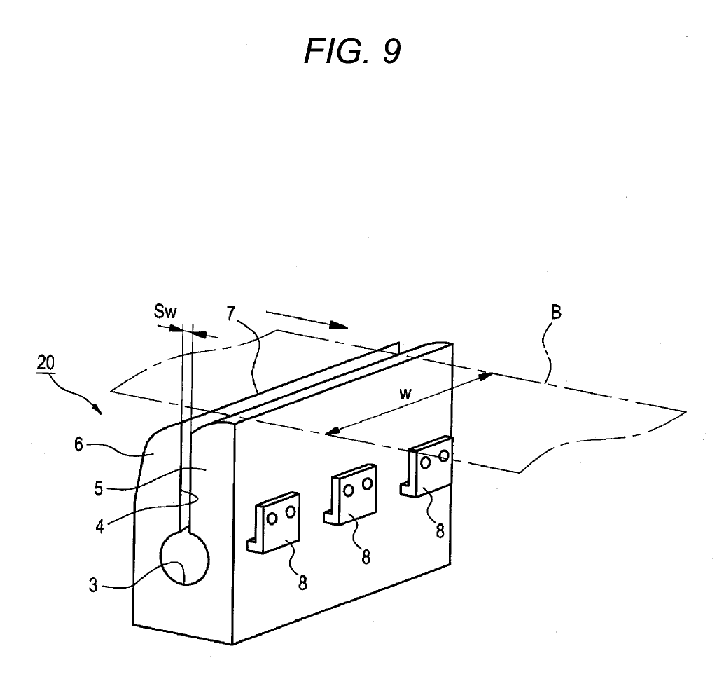

FIG. 9 illustrates a modification of the coating apparatus. The coating apparatus 20 is basically structurally identical to the coating apparatus of FIG. 3, except that the doctor edge portion 5 has a plurality of (three in FIG. 9) adjusters 8 attached to its exterior surface for adjusting the clearance SW of the opening 7 of the slot 4. Each adjuster 8 is clampably attached by adjusting screws. By the tightening of the adjusting screws, the doctor edge portion 5 is elastically deformed to adjust the clearance SW of the opening 7 of the slot 4. The clearance SW of the opening 7 is adjusted by the adjusters 8 such that the clearance SW is the maximum at the center and narrows toward opposite ends of the opening 7 along the substrate width direction and that the rate of narrowing decreases from the center toward the opposite ends of the opening 7. The expression “the rate of narrowing decreases toward the opposite ends” means that, when the clearance SW is taken as d, the change of d³ (the cube of d) is made gradually milder in the direction from the center to the opposite ends of the opening 7.

The above described configuration with a distribution of the slot opening clearance may be otherwise achieved. For example, each of the front edge portion 6 and the doctor edge portion 5 is machined under numerical control to form the cavity and the slot having a desired opening clearance distribution; or a separately prepared plate-shaped member may be inserted between the slot-forming sides of the front and the doctor edge portions to provide a desired slot opening clearance distribution.

The nonmagnetic coating composition forming the nonmagnetic coating layer, the magnetic coating composition forming the magnetic coating layer, and the substrate that can be used in the production of magnetic tape will then be described.

The nonmagnetic material contained in the nonmagnetic coating composition is not particularly limited but generally comprises at least a resin, preferably a resin binder having dispersed therein inorganic or organic powder. While the inorganic powder is preferably nonmagnetic powder, the nonmagnetic layer may contain magnetic powder as long as it is substantially nonmagnetic.

The nonmagnetic powder that can be used in the nonmagnetic layer may be selected from inorganic compounds, such as metal oxides, metal carbonates, metal sulfates, metal nitrides, metal carbides, and metal sulfides. Examples of the inorganic compounds include α-alumina having an α-phase content of 90% or more, β-alumina, γ-alumina, θ-alumina, silicon carbide, chromium oxide, cerium oxide, α-iron oxide, hematite, goethite, corundum, silicon nitride, titanium carbide, titanium oxide, silicon dioxide, tin oxide, magnesium oxide, tungsten oxide, zirconium oxide, boron nitride, zinc oxide, calcium carbonate, calcium sulfate, barium sulfate, and molybdenum disulfide. They can be used either individually or in combination.

It is preferred that the nonmagnetic powder be subjected to surface treatment to have a surface layer of one or more of Al₂O₃, SiO₂, TiO₂, ZrO₂, SnO₂, Sb₂O₃, ZnO, and Y₂O₃. Among these surface treating material, preferred for dispersibility are Al₂O₃, SiO₂, TiO₂, and ZrO₂, with Al₂O₃, SiO₂, and ZrO₂ being still preferred. They may be used either individually or in combination. According to the purpose, a composite surface layer can be formed by co-precipitation or a method comprising first applying alumina to the nonmagnetic particles and then treating with silica or vice versa. The surface layer may be porous for some purposes, but a homogeneous and dense surface layer is usually preferred.

The nonmagnetic powder is used in a weight ratio of 0.1 to 20 and a volume ratio of 0.2 to 10 with respect to the binder. JP 59-142741A, JP 61-214127A, and JP 63-140420A disclose incorporating SnO₂ into a nonmagnetic coating. In these techniques, a magnetic coating contains iron oxide or BaFe both having a smaller specific gravity than SnO₂. The proposed nonmagnetic coating formulations are for forming an undercoat layer on which a magnetic coating layer is to be provided and which is much thinner than the magnetic coating layer. Therefore, the techniques disclosed are different from the present invention.

The magnetic particles used in the magnetic layer is not particularly limited. Known ferromagnetic powders may be used, including ferromagnetic alloy powders mainly comprising α-Fe, γ-FeOₓ (where x=1.33 to 1.5), Co-doped γ-FeOₓ (where x=1.33 to 1.5), ferromagnetic alloy powders comprising Fe, Ni or Co as a main component (75% or more), barium ferrite, and strontium ferrite, and iron nitride. The ferromagnetic powders may contain other elements in addition to the main elements, such as Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, and B. Prior to dispersing, the ferromagnetic powder may be subjected to pretreatment with, e.g., a dispersant, a lubricant, a surfactant, an antistatic agent described infra. For the details, reference can be made to JP 44-14090B, JP 45-183723, JP 47-220623, JP 47-22513B, JP 46-28466B, JP 46-387553, JP 47-4286B, JP 47-124223, JP 47-17284B, JP 47-18509B, JP 47-18573B, JP 39-10307B, JP 48-39639B, and U.S. Pat. Nos. 3,026,215, 3,031,341, 3,100,194, 3,242,005, and 3,389,014.

Of the ferromagnetic powders, the ferromagnetic alloy powder may contain a small amount of a hydroxide or an oxide. The ferromagnetic alloy powder can be prepared by known processes including reduction of a composite organic acid complex salt (mainly an oxalate) with a reducing gas (e.g., hydrogen); reduction of iron oxide with a reducing gas (e.g., hydrogen) into Fe or Fe—Co particles; pyrolysis of a metal carbonyl compound; reduction of a ferromagnetic metal by adding a reducing agent (e.g., sodium borohydride, a hypophosphite or hydrazine) to an aqueous solution of the ferromagnetic metal; and vaporization of a metal in a low-pressure inert gas. The resulting ferromagnetic alloy powder may be subjected to a known slow oxidation treatment, including immersion in an organic solvent followed by drying; immersion in an organic solvent, bubbling an oxygen-containing gas through the solvent to form an oxide film, followed by drying; and forming an oxide film in an atmosphere having a controlled oxygen to inert gas ratio without using an organic solvent.

The ferromagnetic powder has a BET specific surface area of 25 to 80 m²/g, preferably 35 to 60 m²/g. With a specific surface area less than 25 m²/m, noise is high. A specific surface area more than 80 m²/g results in poor surface properties. The ferromagnetic powder has a crystallite size of 10 to 45 nm, preferably 15 to 35 nm. The iron oxide ferromagnetic powder has a saturation magnetization (as) of 50 emu/g or more, preferably 70 emu/g or more. The as of the ferromagnetic metal powder is preferably 100 emu/g or more.

The ferromagnetic powder preferably has a residual magnetization r1500 of 1.5% or less, more preferably 1.0% or less. The term “residual magnetization r1500” denotes a percentage of the magnetization left behind when a magnetic recording medium is first given a magnetic field to saturation in one direction and then a magnetic field of 1500 Oe in the opposite direction. The ferromagnetic powder preferably has a water content of 0.01% to 2%. The water content of the ferromagnetic powder is preferably optimized according to the kind of the binder. The γ-iron oxide preferably has a tap density of 0.5 g/cc or more, more preferably 0.8 g/cc or more.

In using γ-iron oxide, a ratio of divalent iron to trivalent iron preferably ranges from 0% to 20%, more preferably from 5% to 10%. An atomic ratio of cobalt to iron is preferably 0% to 15%, more preferably 2% to 8%. It is preferable to optimize the pH of the ferromagnetic powder according to the binder used. The pH range of the ferromagnetic powder is 4 to 12, preferably 6 to 10. If desired, the ferromagnetic powder may be subjected to surface treatment with from 0.1% to 10% of Al, Si, or P, or an oxide thereof based on the ferromagnetic powder. Such surface treatment reduces an adsorption of a lubricant, e.g., fatty acids, to 100 mg/m² or less. While the ferromagnetic powder can contain soluble inorganic ions, such as Na, Ca, Fe, Ni, and Sr, presence of up to 500 ppm of such inorganic ions is little influential on the characteristics.

The ferromagnetic powder preferably has as low a void as possible. The void is preferably up to 20% by volume, more preferably 5% by volume or lower. The shape of the ferromagnetic powder is not limited as long as the above-defined requirements with respect to particle size are satisfied and may be an acicular form, a particulate form, a grain form, or a tabular form. In order to control SFD of the ferromagnetic powder to 0.6 or smaller, it is necessary to narrow the coercive force (Hc) distribution of the powder. This can be achieved by, for example, optimization of particle size distribution of goethite, prevention of sintering of γ-hematite, and making cobalt deposition slower than conventionally employed in the preparation of Co-doped iron oxide.

Tabular hexagonal ferrites, such as barium ferrite and strontium ferrite, and hexagonal Co powder can also be used as a ferromagnetic powder. Barium ferrite to be used has a particle diameter of 0.001 to 1 μmm, a thickness/diameter ratio of ½ to 1/20, a specific gravity of 4 to 6 g/cc, and a specific surface area of from 1 to 60 m²/g.

The binders that can be used in the nonmagnetic and the magnetic layer include conventionally known thermoplastic resins, thermosetting resins and reactive resins, and mixtures thereof. Thermoplastic resins used as a binder generally have a glass transition temperature of −100° to 150° C., a number average molecular weight of 1,000 to 200,000, preferably 10,000 to 100,000, and a degree of polymerization of about 50 to 1000. Examples of such thermoplastic resins include homo- or copolymers containing a unit derived from vinyl chloride, vinyl acetate, vinyl alcohol, maleic acid, acrylic acid, an acrylic ester, vinylidene chloride, acrylonitrile, methacrylic acid, a methacrylic ester, styrene, butadiene, ethylene, vinyl butyral, vinyl acetal, a vinyl ether, etc.; polyurethane resins; and various rubber resins. Useful thermosetting or reactive resins include phenolic resins, epoxy resins, thermosetting polyurethane resins, urea resins, melamine resins, alkyd resins, reactive acrylic resins, formaldehyde resins, silicone resins, epoxy-polyamide resins, polyester resin/isocyanate prepolymer mixtures, polyester polyol/polyisocyanate mixtures, and polyurethane/polyisocyanate mixtures. For the details of these resin binders, Plastic Handbook, Asakura Shoten (publisher) can be referred to. Known electron beam (EB)-curing resins can also be used in each layer. The details of the EB-curing resins and methods of producing them are described in JP 62-256219A. The above-recited binder resins can be used either individually or as a combination thereof. Examples of preferred binder formulations include a combination of (a) a polyurethane resin and (b) at least one vinyl chloride resin selected from polyvinyl chloride, a vinyl chloride-vinyl acetate copolymer, a vinyl chloride-vinyl acetate-vinyl alcohol copolymer, and a vinyl chloride-vinyl acetate-maleic anhydride copolymer, and a combination of (a), (b), and (c) polyisocyanate.

The polyurethane resin includes those of known structures, such as polyester polyurethane, polyether polyurethane, polyether polyester polyurethane, polycarbonate polyurethane, polyester polycarbonate polyurethane, and polycaprolactone polyurethane. In order to ensure dispersing capabilities and durability, it is preferred to introduce into the above-recited binder resins at least one polar group by copolymerization or through addition reaction, the polar group being selected from —COOM, —SO₃M, —OSO₃M, —P═O(OM)₂, —O—P═O(OM)₂ (wherein M is a hydrogen atom or an alkali metal base), —OH, —NR₂, —N⁺R₃ (wherein R is a hydrocarbon group), an epoxy group, —SH, —CN, and so on. The amount of the polar group to be introduced is 10⁻¹ to 10⁻⁸ mol/g, preferably 10⁻² to 10⁻⁶ mol/g.

Examples of commercially available binder resins that can be used in the invention are VAGH, VYHH, VMCH, VAGF, VAGD, VROH, VYES, VYNC, VMCC, XYHL, XYSG, PKHH, PKHJ, PKHC, and PKFE (from Union Carbide Corp.); MPR-TA, MPR-TA5, MPR-TAL, MPR-TSN, MPR-TMF, MPR-TS, and MPR-TM (from Nisshin Chemical Industry Co., Ltd.); 1000w, DX80, DX81, DX82, and DX83 (from Denki Kagaku Kogyo K.K.); MR110, MR100, and 400X-110A (from Zeon Corp.); Nipporan series N2301, N2302, and N2304 (from Nippon Polyurethane Industry Co., Ltd.); Pandex series T-5105, T-R3080, and T-5201, Barnock series D-400 and D-210-80, and Crisvon series 6109 and 7209 (from Dainippon Ink & Chemicals, Inc.); Vylon UR series 8200, 8300, and RV530, and RV280 (from Toyobo Co., Ltd.); Daiferamin series 4020, 5020, 5100, 5300, 9020, 9022, and 7020 (from Dainichiseika Color & Chemicals Mfg. Co., Ltd.); MX5004 (from Mitsubishi Chemical Corp.); Sanprene SP-150 (from Sanyo Chemical Industries, Ltd.); and Saran F series 310 and 210 (from Asahi Chemical Industry Co., Ltd.).

The binder is used in an amount of 5% to 50% by weight, preferably 10% to 30% by weight, based on the ferromagnetic powder. Where a vinyl chloride resin, a polyurethane resin, and polyisocyanate are used in combination, their amounts are selected from a range of 5% to 30% by weight, a range of 2% to 20% by weight, and a range of 2% to 20% by weight, respectively.

The polyurethane to be used preferably has a glass transition temperature of −50° to 100° C., an elongation at break of 100% to 2000%, a stress at rupture of 0.05 to 10 kg/mm², and a yield point of 0.05 to 10 kg/mm².

The magnetic tape according to the present embodiment has two coating layers on the substrate. The two layers may have different binder formulations in terms of the binder content, the proportions of a vinyl chloride resin, a polyurethane resin, polyisocyanate, and other resins, the molecular weight of each resin, the amount of the polar group introduced, and other physical properties of the resins.

The polyisocyanate that can be used in the binder formulation includes tolylene diisocyanate, 4,4′-diphenylmethane diisocyanate, hexamethylene diisocyanate, xylylene diisocyanate, naphthylene-1,5-diisocyanate, o-toluidine diisocyanate, isophorone diisocyanate, and triphenylmethane triisocyanate. Further included are reaction products between these isocyanate compounds and polyols and polyisocyanates produced by condensation of the isocyanates. Examples of commercially available polyisocyanates useful in the invention are Coronate L, Coronate HL, Coronate 2030, Coronate 2031, Millionate MR, and Millionate MTL (from Nippon Polyurethane Industry Co., Ltd.); Takenate D-102, Takenate D-110N, Takenate D-200, and Takenate D-202 (from Takeda Chemical Industries, Ltd.); and Desmodur L, Desmodur IL, Desmodur N, and Desmodur HL (from Sumitomo Bayer Urethane Co., Ltd.). They can be used in each layer, either alone or as a combination of two or more thereof taking advantage of difference in curing reactivity.

The magnetic coating layer may contain carbon black. Examples of the carbon black species that can be used in the magnetic coating layer include furnace black for rubber, thermal black for rubber, carbon black for colors, and acetylene black. The carbon black preferably has a specific surface area of 5 to 500 m²/g, a oil (DBP) absorption of 10 to 400 ml/100 g, a particle size of 5 to 300 mμm, a pH of 2 to 10, a water content of 0.1% to 10% by weight, and a tap density of 0.1 to 1 g/cc. Specific examples of commercially available carbon black products include Black Pearls 2000, 1300, 1000, 900, 800, and 700, and Vulcan XC-72 (from Cabot Corp.); #80, #60, #55, #50, and #35 (from Asahi Carbon Co., Ltd.); #2400B, #2300, #900, #1000, #30, #40, and #10B (from Mitsubishi Chemical Corp.); and Conductex SC, RAVEN 150, 50, 40, and 15 (from Columbian Carbon) Carbon black having been surface treated with a dispersant, etc., resin-grafted carbon black, or carbon black with its surface partially graphitized may be used. Carbon black may previously been dispersed in a binder before being added to a magnetic coating composition. The above described carbon black species may be used either individually or as a combination thereof. The carbon black, if added, is preferably used in an amount of 0.1% to 30% by weight with respect to the ferromagnetic powder. Carbon black serves for antistatic control, reduction of frictional coefficient, reduction of light transmission, film strength enhancement, and the like. These functionalities vary depending on the species. Accordingly, it is possible to optimize the kinds, amounts, and combinations of the carbon black species for each layer according to the intended purpose, taking into consideration the above-mentioned characteristics, such as particle size, oil absorption, conductivity, pH, and so forth. For example, carbon black having high conductivity may be used in the nonmagnetic layer for static charge control, and carbon black of large size may be used in the magnetic layer for reduction of coefficient of friction. In selecting carbon black species for use in the invention, reference can be made, e.g., to Carbon Black Kyokai (ed.), Carbon Black Binran.

Known abrasives mostly having a Mohs hardness of 6 or higher may be incorporated into the magnetic layer. Examples of suitable abrasives include α-alumina having an α-phase content of 90% or more, β-alumina, silicon carbide, chromium oxide, cerium oxide, α-iron oxide, corundum, artificial diamond, silicon nitride, silicon carbide, titanium carbide, titanium oxide, silicon dioxide, and boron nitride. These abrasives may be used either individually or as a mixture thereof or as a composite thereof (an abrasive surface treated with another). Existence of impurity compounds or elements, which are sometimes observed in the abrasives, will not affect the effect as long as the content of the main component is 90% by weight or higher. The abrasive preferably has a particle size of 0.01 to 2 μm. Abrasives different in particle size may be used in combination, if necessary, or a single kind of an abrasive having a broadened size distribution may be used to produce the same effect. The abrasives preferably have a tap density of 0.3 to 2 g/cc, a water content of 0.1% to 5% by weight, a pH of 2 to 11, and a specific surface area of 1 to 30 m²/g. The abrasive grains may be needle-like, spherical or cubic. Angular grains are preferred for high abrasive performance.

Examples of commercially available abrasives that can be used are AKP-20, AKP-30, AKP-50, and HIT-50 (from Sumitomo Chemical Co., Ltd.); G-5, G-7, and S-1 (from Nippon Chemical Industrial Co., Ltd.); and 100ED and 140ED (from Toda Kogyo Corp.). Understandably, the kinds, amounts, and the combination of the abrasives to be added may be optimized for each layer according to the purpose. The abrasives may previously be dispersed in a binder before being added to the magnetic coating composition. The amount of the abrasive to be used in the magnetic layer is preferably such that there will be at least five abrasive grains per 100 μm² on the surface and edge faces of the magnetic tape.

The magnetic and the nonmagnetic layer may further contain other additives producing lubricating effects, antistatic effects, dispersing effects, plasticizing effects, and the like. Examples of useful additives include molybdenum disulfide, tungsten disulfide, graphite, boron nitride, graphite fluoride, silicone oils, polar group-containing silicones, fatty acid-modified silicones, fluorine-containing silicones, fluorine-containing alcohols, fluorine-containing esters, polyolefins, polyglycols, alkylphosphoric esters and alkali metal salts thereof, alkylsulfuric esters and alkali metal salts thereof, polyphenyl ethers, fluorine-containing alkylsulfuric esters and their alkali metal salts, saturated or unsaturated, straight-chain or branched monobasic fatty acids having 10 to 24 carbon atoms and their metal (e.g., Li, Na, K, Cu) salts, saturated or unsaturated, straight-chain or branched mono- to hexahydric alcohols having 12 to 22 carbon atoms, alkoxyalcohols having 12 to 22 carbon atoms, mono-, di- or tri-fatty acid esters between saturated or unsaturated, straight-chain or branched monobasic fatty acids having 10 to 24 carbon atoms and at least one of mono- to hexahydric, saturated or unsaturated, and straight-chain or branched alcohols having 2 to 12 carbon atoms, fatty acid esters of polyalkylene oxide monoalkyl ethers, fatty acid amides having 8 to 22 carbon atoms, and aliphatic amines having 8 to 22 carbon atoms. Examples of the fatty acids are lauric acid, myristic acid, palmitic acid, stearic acid, behenic acid, oleic acid, elaidic acid, linoleic acid, and linolenic acid. Examples of the esters are butyl stearate, octyl stearate, amyl stearate, isooctyl stearate, octyl myristate, butoxyethyl stearate, anhydrosorbitan monostearate, anhydrosorbitan distearate, anhydrosorbitan triacetate. Examples of the alcohols are oleyl alcohol and lauryl alcohol.

Examples of useful surfactants include nonionic ones, such as alkylene oxide types, glycerol types, glycidol types, and alkylphenol ethylene oxide adducts; cationic ones, such as cyclic amines, ester amides, quaternary ammonium salts, hydantoin derivatives, heterocyclic compounds, phosphonium salts, and sulfonium salts; anionic ones containing an acidic group, such as a carboxyl group, a sulfonic acid group, a phosphoric acid group, a sulfuric ester group, or a phoshoric ester group; and amphoteric ones, such as amino acids, aminosulfonic acids, amino alcohol sulfuric or phosphoric esters, and alkyl betaines. For the details of the surfactants, refer to Kaimen Kasseizai Binran, Sangyo Tosho K.K. The lubricants, surfactants, antistatics, and like additives do not always need to be 100% pure and may contain impurities, such as isomers, unreacted materials, by-products, decomposition products, and oxidation products. Nevertheless, the proportion of the impurities is preferably 30% by weight at the most, more preferably 10% or less.

The kinds and amounts of the lubricants and the surfactants may be chosen as appropriate for each of the nonmagnetic layer and the magnetic layer. The following is a few illustrative examples of possible manipulations using these additives. (1) Bleeding of fatty acid additives is controlled by using fatty acids having different melting points between the magnetic layer and the nonmagnetic layer. (2) Bleeding of ester additives is controlled by using esters different in boiling point or polarity between the magnetic layer and the nonmagnetic layer. (3) Coating stability is improved by adjusting the amount of a surfactant. (4) The amount of the lubricant in the nonmagnetic layer is increased to improve the lubricating effect.

All or part of the additives may be added at any stage of preparing a magnetic coating composition. For example, the additives may be blended with the ferromagnetic powder before kneading, be mixed with the ferromagnetic powder, the binder, and a solvent in the step of kneading, or be added during or after the step of dispersing or immediately before application. Examples of commercially available lubricants that can be used include NAA-102, NAA-415, NAA-312, NAA-160, NAA-180, NAA-174, NAA-175, NAA-222, NAA-34, NAA-35, NAA-171, NAA-122, NAA-142, NAA-160, NAA-173K, hardened castor oil fatty acids, NAA-42, NAA-44, Cation SA, Cation MA, Cation AB, Cation BB, Nymeen L-201, Nymeen L-202, Nymeen S-202, Nonion E-208, Nonion P-208, Nonion S-207, Nonion K-204, Nonion NS-202, Nonion NS-210, Nonion HS-206, Nonion L-2, Nonion S-2, Nonion S-4, Nonion O-2, Nonion LP-20R, Nonion PP-40R, Nonion SP-60R, Nonion OP-80R, Nonion OP-85R, Nonion LT-221, Nonion ST-221, Nonion OT-221, Monogly MB, Nonion DS-60, Anon BF, Anon LG, butyl stearate, butyl laurate, and erucic acid from NOF Corp.; oleic acid from Kanto Chemical Co., Ltd.; FAL 205 and FAL 123 from Takemoto Yushi K.K.; Enujelv OL, Enujelv IPM, and Sansosyzer E4030 from New Japan Chemical Co., Ltd.; TA-3, KF-96, KF-96L, KF-96H, KF-410, KF-420, KF-965, KF-54, KF-50, KF-56, KF-907, KF-851, X-22-819, X-22-822, KF-905, KF-700, KF-393, KF-857, KF-860, KF-865, X-22-980, KF-101, KF-102, KF-103, X-22-3710, X-22-3715, KF-910, and KF-3935 from Shin-Etsu Chemical Co., Ltd.; Amid P, Amid C, and Armoslip CP from Lion Armour Co., Ltd.; Duomeen TDO from Lion Corp.; BA-41G from Nisshin Oil Mills, Ltd.; and Profan 2012E, Newpol PE 61, Ionet MS-400, Ionet MO-200, Ionet DL-200, Ionet DS-300, Ionet DS-1000, and Ionet DO-200 from Sanyo Chemical Industries, Ltd.).

Organic solvents that can be used in the coating compositions include ketones, e.g., acetone, methyl ethyl ketone, methyl isobutyl ketone, diisobutyl ketone, cyclohexanone, isophorone, and tetrahydrofuran; alcohols, e.g., methanol, ethanol, propanol, butanol, isobutyl alcohol, isopropyl alcohol, and methylcyclohexanol; esters, e.g., methyl acetate, butyl acetate, isobutyl acetate, isopropyl acetate, ethyl lactate, and glycol acetate; glycol ethers, e.g., glycol dimethyl ether, glycol monoethyl ether, and dioxane; aromatic hydrocarbons, e.g., benzene, toluene, xylene, cresol, and chlorobenzene; chlorinated hydrocarbons, e.g., methylene chloride, ethylene chloride, carbon tetrachloride, chloroform, ethylene chlorohydrin, and dichlorobenzene; N,N-dimethylformamide, and hexane. These solvents may be used either individually or in combination at any mixing ratio. The organic solvents do not need to be 100% pure and may contain impurities, such as isomers, unreacted matter, by-products, decomposition products, oxides, and water, in a proportion preferably below 30% by weight, and more preferably below 10% by weight. Where necessary, the kind and amount of the organic solvents to be used may be varied between the magnetic and nonmagnetic layers. For example, a highly volatile solvent may be used in the nonmagnetic layer to improve surface properties; a solvent having high surface tension (e.g., cyclohexanone or dioxane) may be used in the magnetic layer to improve coating stability; or a solvent having a high solubility parameter may be used in the magnetic layer to improve packing density.

In the magnetic tape of the present embodiment, the substrate has a thickness of 1 to 100 μM, preferably 5 to 20 μm; the nonmagnetic layer has a thickness of 0.5 to 10 μm, preferably 1 to 5 μm; and the magnetic layer has a thickness of 0.05 to 1.0 μm, preferably 0.05 to 0.6 μm, more preferably 0.05 to 0.3 μm. The total thickness of the magnetic layer and the nonmagnetic layer ranges from 1/100 to 2 times the thickness of the substrate.

The magnetic tape of the invention may have another nonmagnetic layer between the substrate and the nonmagnetic layer described supra as an undercoat layer enhancing the adhesion therebetween. The nonmagnetic layer as an undercoat layer may have a thickness of 0.01 to 2 μm, preferably 0.05 to 0.5 μm. The magnetic tape may further have a backcoat layer on the opposite side of the substrate to the magnetic layer side. The backcoat layer may have a thickness of 0.1 to 2 μm, preferably 0.3 to 1.0 μm. Any coating compositions known for the undercoat layer and the backcoat layer are usable.

The substrate of the magnetic tape can be a film of a polyester, such as a polyethylene terephthalate film, a biaxially stretched film of polyethylene terephthalate, and a polyethylene naphthalate film, a polyolefin film, a cellulose triacetate film, a polycarbonate film, a polyamide film, a polyimide film, a polyamide-imide film, a polysulfone film, an aramid film, and an aromatic polyamide film. The substrate may previously be subjected to a surface treatment, such as a corona discharge treatment, a plasma treatment, an adhesion enhancing treatment, a heat treatment, and a cleaning treatment. The substrate should have a highly smooth surface as with a centerline average surface roughness of 0.03 μm or smaller, preferably 0.02 nm or smaller, more preferably 0.01 μm or smaller. It is desirable for the substrate to be free from projections of 1 μm or greater in height. The surface roughness profile of the substrate is arbitrarily controllable by adjusting the size and amount of fillers to be added. Fillers include an oxide or carbonate of Ca, Si, or Ti and organic fine powders, e.g., acrylic resin powders. The substrate preferably has an F-5 value ranging from 5 to 50 kg/mm² in the tape running direction (MD) and from 3 to 30 kg/mm² in the tape width direction (TD). The F-5 value in the MD is generally higher than that in the TD, but this is not the case when the substrate is required to be stronger in the TD than in the MD.

The thermal shrinkage of the substrate when heated at 100° C. for 30 minutes is preferably 3% or less, still preferably 1.5% or less, in both TD and MD. The thermal shrinkage at 80° C. for 30 minutes is preferably 1% or less, still preferably 0.5% or less, in both MD and TD. The substrate preferably has a breaking strength of 5 to 100 kg/mm² in both directions and an elastic modulus of 100 to 2000 kg/mm².

The method of preparing the coating composition includes at least the steps of kneading and dispersing and, if desired, the step of mixing which is provided before or after the step of kneading and/or the step of dispersing. Each step may be carried out in two or more divided stages. Any of the materials, including the ferromagnetic powder, binder, carbon black, abrasive, antistatic, lubricant, and solvent, may be added at the beginning of or during any step. Individual materials may be added in divided portions in two or more steps. For example, polyurethane may be added dividedly in the kneading step, the dispersing step, and a mixing step that is provided for adjusting the viscosity of the dispersion.

Known techniques for the preparation of a coating composition can be applied to part of the method. The kneading step is preferably performed using a kneading machine with high kneading power, such as a continuous kneader or a pressure kneader, to provide a magnetic tape having a high magnetic flux density (Br). Where a continuous kneader or a pressure kneader is used, the magnetic powder, a part (preferably at least 30% of the total binder) or the whole of the binder, and 15 to 500 parts by weight of a solvent per 100 parts by weight of the ferromagnetic powder are kneaded together. For the details of the kneading operation, reference can be made to JP 1-106338A and JP 1-79274A.

Any known coating unit may be incorporated into the apparatus for producing the magnetic tape having dual layer structure formed by sequential coating. For example, coating units commonly used in the application of a magnetic coating may be used, including a gravure coater, a roll coater, a blade coater, and an extrusion coater.

In order to prevent reduction of electromagnetic characteristics due to agglomeration of ferromagnetic particles, it is advisable to give shear to the coating composition in the coating head. The techniques taught in JP 62-95174A and JP 1-236968A are suited for shear application. The magnetic coating composition preferably satisfies the viscosity requirement specified in JP 3-8471A.

Magnetic alignment is preferably carried out using a combination of a solenoid having a magnetic power of at least 1000 G and a cobalt magnet having a magnetic power of at least 2000 G. A step of moderate drying is preferably provided upstream the step of alignment so that the degree of alignment reaches the highest after final drying.

Calendering is carried out with rolls of heat-resistant plastics, such as epoxy resins, polyimide, polyamide, and polyimide-amide. Calendering may be conducted using metal rolls. Calendering is preferably carried out at a temperature of 70° C. or higher, still preferably 80° C. or higher, under a linear pressure of 200 kg/cm or higher, still preferably 300 kg/cm or higher, at a speed of 20 to 700 m/min.

The magnetic tape of the invention preferably has a coefficient of friction of 0.5 or smaller, still preferably 0.3 or smaller, against SUS 420J on each of the magnetic layer side and the opposite side. The magnetic tape preferably has a surface resistivity of 10⁻⁵ to 10⁻¹² Ω/sq. The magnetic layer preferably has an elastic modulus at 0.5% elongation of 100 to 2000 kg/mm² in both the MD and TD and a breaking strength of 1 to 30 kg/cm². The magnetic tape preferably has an elastic modulus of 100 to 1500 kg/mm², a residual elongation of 0.5% or less, and a thermal shrinkage of not more than 1%, still preferably not more than 0.5%, even still preferably 0.1% or less, at or below 100° C., in both the MD and TD.

The residual solvent content in the magnetic layer is preferably 100 mg/m² or less, still preferably 10 mg/m² or less. It is preferred that the residual solvent content in the magnetic layer be lower than that in the nonmagnetic layer. Each of the magnetic layer and the nonmagnetic layer preferably has a void of 30% by volume or less, still preferably 10% by volume or less. While it is preferred for the magnetic layer to have a higher void than the nonmagnetic layer, the reverse relation is possible as long as the void of the nonmagnetic layer is not more than 20%.

### EXAMPLES

The inventors conducted the following test to examine the relation among the coating thickness distribution, the shape of a substrate roll, and the condition of the substrate after thermal cure. In the test, only a nonmagnetic coating was applied to a substrate to an average dry thickness of 1 μm.

The coating apparatus used to carry out the test in Examples and Comparative Example had a coating head having a dimension of 900 mm in the substrate width direction (TD) and configured to apply the coating over a coating width of 800 mm on a moving substrate. The cavity of the coating head had a circular cross-section with a 10 mm radius. The substrate moved at a speed of 300 m/min, and the coating was applied to a thickness of 5 μm.

A 820 mm wide web of a polyethylene naphthalate film was used as a substrate. After coated, the substrate was wound onto a 300 mm diameter core to make a roll of the coated substrate.

The coating thickness distribution along the TD was determined with a thickness meter to find nonuniform occurrence of a thickness unevenness of 0.10 μm. Subsequently, the substrate roll was calendered to smooth the surface of the coating layer and then thermally treated in a constant temperature chamber at 60° C. for 48 hours.

The influence of a coating thickness distribution on the prevention of scatterwinding was evaluated by counting the scatterwinds per 100 turns during winding the coated substrate onto a core. Displacement of the coating layer of the inner windings and that of the outer windings of the substrate roll after the thermal treatment was determined with a laser displacement meter to examine deformation of the substrate in the inner windings and that of the outer windings of the roll due to the thermal treatment.

### Example 1

The coating head of the coating apparatus used in Example 1 had a curved cavity as shown in FIGS. 3 to 5. Similarly to the embodiment illustrated in FIG. 5, when viewed from the front edge portion side, the cavity 3 was defined by an upper and a lower edge that were equally shaped arcs with a curvature R increasing from the center to the opposite ends along the width direction of the moving substrate.

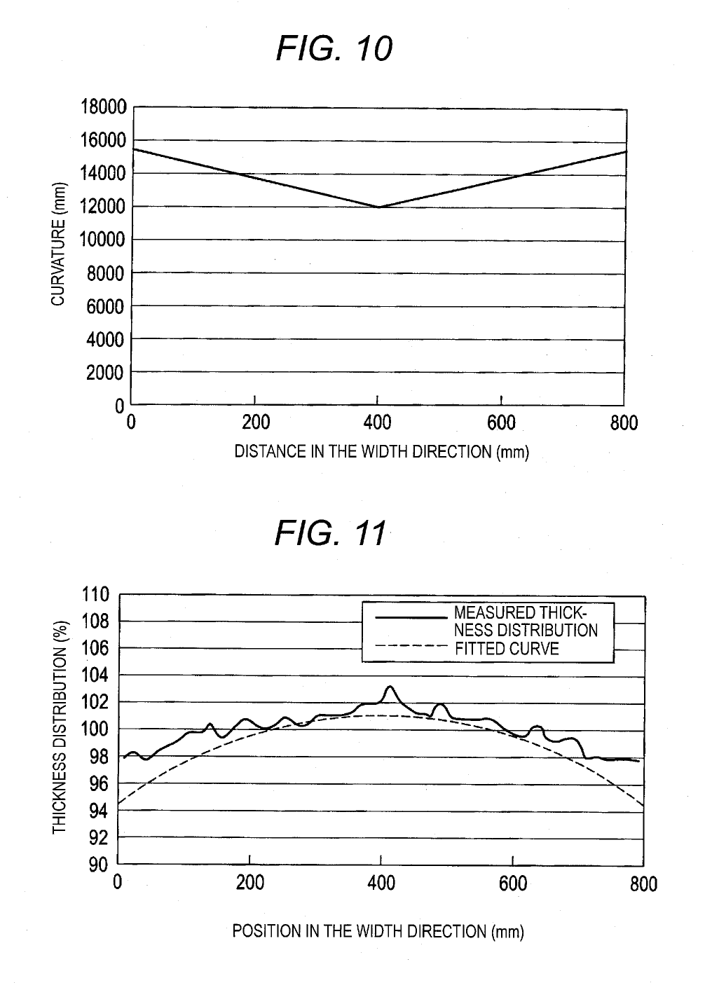

FIG. 10 is a graph showing the curvature of the cavity varying with position in the substrate width direction, in which the abscissa represents the distance (mm) from one end of the cavity in the substrate width direction, and the ordinate represents the curvature (mm). The curvature at the center of the arc shape of the cavity was about 12000 mm. The curvature increased from the center toward both ends of the arc to reach about 15000 mm at the ends.

The thickness distribution of the resulting coating layer is shown in FIG. 11, in which the abscissa represents a position x in the cavity along the substrate width direction, specifically the distance (mm) from one edge of the 800 mm wide coating layer, and the ordinate represents the thickness distribution of the coating layer. In FIG. 11, the solid line represents the measured thickness distribution, while the dotted line is a fitted curve calculated by least square fit based on the measured values. According to the fitted curve, the thickness was the largest at the lateral center of the coating layer (x=400 mm) and decreased toward both lateral edges to reach the smallest at the edges (i.e., x=0 mm and x=800 mm).

### Example 2

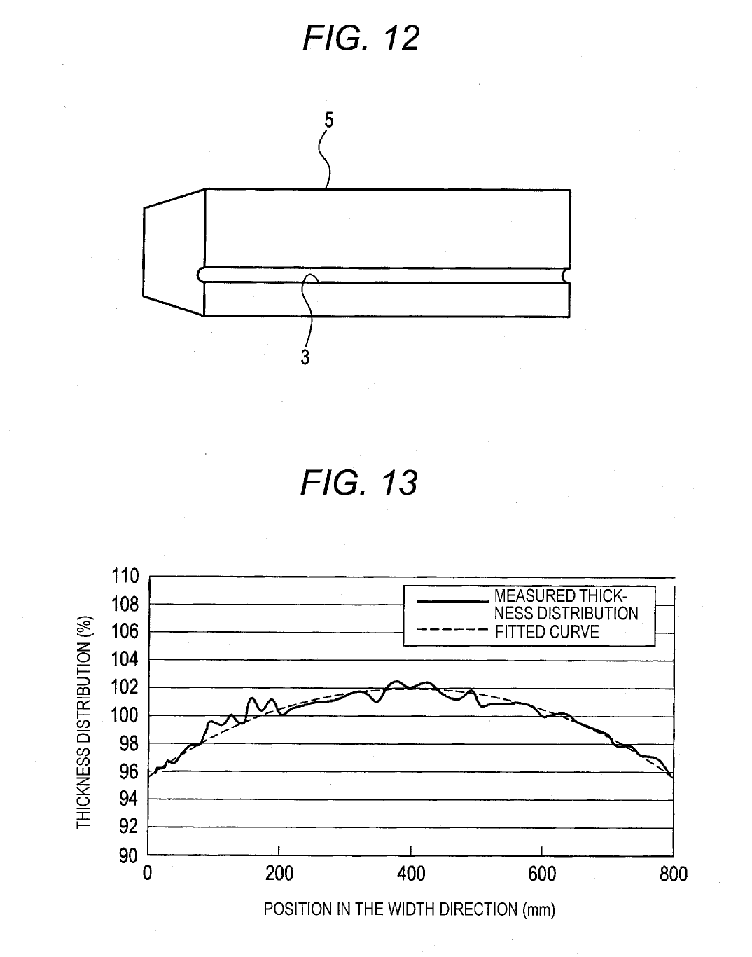

The cavity of the coating head used in Example 2 is shown in FIG. 12. As illustrated, the cavity was defined by an upper and a lower straight line parallel to each other. That is, the depth of the slot was constant in the substrate width direction. As illustrated in FIG. 9, the coating head had adjusters 8 for adjusting the clearance SW of the opening 7 of the slot 4. The clearance SW of the opening 7 was adjusted by the adjusters 8 such that the clearance SW narrowed from a position with the maximum clearance and decreased toward opposite ends of the opening 7 at a rate of narrowing decreasing toward the opposite ends of the opening so that the amount (thickness) of the coating applied to the substrate might have substantially the same thickness distribution as obtained in Example 1.

### Comparative Example 1

The coating head of the coating apparatus used in Comparative Example 1 had a cavity defined by an upper and a lower edge that were equally shaped arcs with a constant curvature R from the center to the opposite ends of the cavity along the substrate width direction.

The thickness distribution of the resulting coating layer is shown in FIG. 13, in which the abscissa represents a position x in the cavity along the substrate width direction, specifically the distance (mm) from one edge of the 800 mm wide coating layer, and the ordinate represents the thickness distribution of the coating layer. In FIG. 13, the solid line represents the measured thickness distribution, while the dotted line is a fitted curve calculated by least square fit based on the measured values. The curvature of the fitted curve was almost constant from the lateral center (x=400 mm) to both edges (i.e., x=0 mm and x=800 mm) of the coating layer.

The results of evaluation are shown in Table 1 below.

TABLE 1

| | | Deformation of Substrate by | |
|---|---|---|---|
| | Number of | Thermal Treatment | |
| | Scatterwinds | Inner Windings | Outer Windings |
| Example 1 | 0/100 | not observed | not observed |
| Example 2 | 0/100 | not observed | not observed |
| Comparative | 3/100 | slightly | not observed |
| Example 1 | | observed | |

It is seen from the results of Examples 1 and 2 that forming the coating layer with the specified thickness distribution allows for preventing scatterwinding during winding into roll form and preventing thermal deformation of the substrate in the inner and the outer windings.

In Comparative Example 1, on the other hand, three scatterwinds occurred when the substrate was wound 100 turns around the core. Although the substrate escaped thermal deformation in the outer windings, occurrence of thermal deformation was observed in the inner windings.

It has now been confirmed that occurrence of scatterwinds and thermal deformation of the substrate can be prevented by applying a coating to the substrate to provide a thickness distribution curve across the substrate such that the thickness decreases from a position with the maximum thickness to the opposite ends along the substrate width direction and that the curvature of the curve at both ends thereof is larger than that of the position with the maximum thickness.

While the invention has been described with reference to specific embodiments and examples, it should be understood that various modifications can be made therein as follows.

The position with the maximum coating thickness is not limited to the lateral center of the substrate. What is required is that the thickness decreases from the position with the maximum thickness to both opposite edges of the substrate in the substrate width direction and that the curvature at each end of the thickness distribution curve is larger than that at the position with the maximum thickness.

At least one of the end portions of the coating thickness distribution curve having a larger curvature than the position with the maximum thickness may contain a linear portion (a segment with an almost infinitely large curvature) within a range that does not interfere with air bleed.

At least one of the end portions of the coating thickness distribution curve having a larger curvature than the position with the maximum thickness may contain two or more segments different in curvature such that the curvature increases stepwise from the proximal segment to the distal segment in that end portion.

In this wise, the coating thickness distribution curve may have different curvatures and/or different numbers of stepwise changes in curvature between the left-hand side and the right-hand side of the position with the maximum thickness.

The invention discloses the following.

(1) A method of coating a moving web of a substrate with a coating. The method includes applying the coating to the substrate to provide a coating thickness distribution curve along the width direction of the substrate such that the coating thickness decreases from a position where the thickness is the maximum to the opposite ends of the curve and that the distribution curve has the least curvature at the position with the maximum thickness and contains an end portion having a larger curvature than that of the position with the maximum thickness on both sides of the position with the maximum thickness.
(2) The method (1), wherein at least one of the end portions of the coating thickness distribution curve contains two or more segments different in curvature. The curvature of the two or more segments increases stepwise from the proximal segment to the distal segment in that end portion.
(3) The method (1), wherein the coating thickness distribution curve has a gradually increasing curvature from the position with the maximum thickness toward the opposite ends thereof.
(4) The method (1), wherein the coating thickness distribution curve has a continuously or stepwise increasing curvature from the position with the maximum thickness toward the opposite ends thereof.
(5) A coating apparatus for coating a moving web of a substrate with a coating. The apparatus includes a cavity for containing a coating, a slot connecting to the cavity and having an opening through which the coating is applied to the substrate, and a configuration for adjusting the weight of the coating to be applied to the substrate to provide a coating weight distribution curve across the substrate such that the coating weight decreases from a position where it reaches the maximum to the opposite ends along the width direction of the substrate and that the distribution curve has a first portion including the position with the maximum coating weight and having the least curvature and a second portion which is located on each side of the first portion and has a larger curvature than the position with the maximum coating weight.
(6) The coating apparatus (5), wherein the configuration for adjusting the coating weight is a configuration for narrowing the clearance of the opening of the slot from a position where the clearance is the maximum toward opposite ends of the opening along the substrate width direction at a decreasing rate of narrowing from the position with the maximum clearance toward the opposite ends of the opening.
(7) The coating apparatus (5), wherein the configuration for adjusting the coating weight is a configuration for increasing the depth of the slot from its opening to the cavity from a position where the depth is the smallest to the opposite ends of the opening along the substrate width direction at a decreasing rate of increase from the position with the smallest depth toward the opposite ends of the opening.
(8) A method of making a wound roll of a web of a substrate coated with a coating layer. The method includes the step of applying a coating to the substrate to provide a thickness distribution curve across the substrate such that the thickness of the coating layer decreases from a position where the thickness is the maximum to the opposite edges of the substrate along the width direction of the substrate and that the thickness distribution curve contains a portion including the position with the maximum thickness and having the least curvature and a portion which is located on each side of the first described portion and has a larger curvature than the position with the maximum coating thickness and the step of winding the web of the substrate coated with the coating into a roll.
(9) A magnetic tape including a substrate and a magnetic layer obtained by using the method (8). In the method, the coating contains magnetic particles, the step of applying the coating is followed by drying and solidifying the applied coating to form a magnetic layer, and the step of winding into a roll is followed by slitting the substrate to width.

What is claimed is:

1. A method of coating a moving web of a substrate with a coating, comprising applying the coating to the substrate to provide a coating thickness distribution curve along a width direction of the substrate such that:
the coating thickness decreases from a position where the thickness is the maximum to the opposite ends of the curve and that
the distribution curve has the least curvature at the position with the maximum thickness and contains an end portion having a larger curvature than that of the position with the maximum thickness on both sides of the position with the maximum thickness.

2. The method according to claim 1, wherein at least one of the end portions contains two or more segments different in curvature, the curvature of the two or more segments increasing stepwise from the proximal segment to the distal segment.

3. The method according to claim 1, wherein the coating thickness distribution curve has a gradually increasing curvature from the position with the maximum thickness toward the opposite ends thereof.

4. The method according to claim 1, wherein the coating thickness distribution curve has a continuously or stepwise increasing curvature from the position with the maximum thickness toward the opposite ends thereof.

5. A coating apparatus for coating a moving web of a substrate with a coating, comprising:
a cavity for containing a coating,
a slot connecting to the cavity and having an opening through which the coating is applied to the substrate, and
a configuration for adjusting the weight of the coating to be applied to the substrate to provide a coating weight distribution curve across the substrate such that the coating weight decreases from a position where the coating weight reaches the maximum to the opposite ends of the curve and that the distribution curve has a first portion including the position with the maximum coating weight and having the least curvature and a second portion which is located on each side of the first portion and has a larger curvature than the position with the maximum coating weight.

6. The coating apparatus according to claim 5, wherein the configuration for adjusting the coating weight is a configuration for narrowing the clearance of the opening of the slot from a position where the clearance is the maximum toward opposite ends of the opening along the substrate width direction at a decreasing rate of narrowing from the position with the maximum clearance toward the opposite ends of the opening.

7. The coating apparatus according to claim 5, wherein the configuration for adjusting the coating weight is a configuration for increasing the depth of the slot from its opening to the cavity from a position where the depth is the smallest to the opposite ends of the opening along the substrate width direction at a decreasing rate of increase from the position with the smallest depth toward the opposite ends of the opening.

8. A method of making a wound roll of a web of a substrate coated with a coating layer, comprising:
applying a coating to the substrate to provide a coating thickness distribution curve across the substrate such that the coating thickness decreases from a position where the thickness is the maximum to the opposite edges of the substrate along the width direction of the substrate and that the distribution curve has a first portion including the position with the maximum thickness and having the least curvature and a second portion which is located on each side of the first portion and has a larger curvature than the position with the maximum thickness and
winding the web of the substrate coated with the coating into roll form.

9. A magnetic tape comprising a substrate and a magnetic layer obtained by the method according to claim 8, wherein the coating contains magnetic particles, the applying of the coating is followed by drying and solidifying the applied coating to form the magnetic layer, and the winding into roll form is followed by slitting the substrate to width.
